(19) United States
(12) Patent Application Publication
(10) Pub. No.: US 2013/0192257 A1
(43) Pub. Date: Aug. 1, 2013

(54) TURBINE SHROUD HANGER WITH DEBRIS FILTER

(71) Applicants: Benjamin Marshall Horine, Cincinnati, OH (US); Jacek Michalczuk, Warsaw (PL); Miroslaw Pilat, Warsaw (PL)

(72) Inventors: Benjamin Marshall Horine, Cincinnati, OH (US); Jacek Michalczuk, Warsaw (PL); Miroslaw Pilat, Warsaw (PL)

(73) Assignee: General Electric Company, Schenectady, NY (US)

(21) Appl. No.: 13/635,773

(22) PCT Filed: Mar. 14, 2011
(86) PCT No.: PCT/US11/28294

§ 371 Date: Feb. 22, 2013

(30) Foreign Application Priority Data
Mar. 18, 2010 (PL) P.390758

(51) Int. Cl. F02C 7/20

(52) U.S. Cl. CPC F02C 7/20
USPC 60/796

(57) ABSTRACT

A turbine shroud hanger apparatus for a gas turbine engine includes: an arcuate shroud hanger having at least one cooling hole passing therethrough, the cooling hole having an inlet and an outlet; and a filter carried by the shroud hanger positioned upstream of the inlet of the cooling hole, the filter having a plurality of openings formed therethrough which are sized to permit air flow through the cooling hole while preventing the entry of debris particles larger than a preselected size into the cooling hole.

### CROSS REFERENCE TO RELATED APPLICATIONS

This is a national stage application under 35 U.S.C. §371(c) of prior-filed, co-pending PCT patent application serial number PCT/US2011/028294, filed on Mar. 14, 2011, which claims priority to Polish Patent Application Serial No. P-390758, filed on Mar. 18, 2010, the entire contents of which are incorporated herein by reference.

### BACKGROUND OF THE INVENTION

Embodiments of this invention relate generally to gas turbine engines, and more particularly to apparatus for preventing obstruction of cooling holes in the turbine sections of such engines.

A typical gas turbine engine includes a turbomachinery core having a high pressure compressor, a combustor, and a high pressure turbine in serial flow relationship. The core is operable in a known manner to generate a primary gas flow. The high pressure turbine includes one or more rotors which extract energy from the primary gas flow. Each rotor comprises an annular array of blades or buckets carried by a rotating disk. The flowpath through the rotor is defined in part by a shroud, which is a stationary structure that circumscribes the tips of the blades or buckets. The shrouds operate in an extremely high temperature environment, and must be cooled by air flow to ensure adequate service life. Typically, the air used for cooling is extracted (bled) from the compressor.

In conventional practice, cooling air is routed to the turbine shrouds through their supporting hardware, commonly referred to as “hangers”. The hangers incorporate small-diameter air passages which can be obstructed by metallic and non-metallic particles entrained in the cooling air flow. When sufficiently plugged, these small air passages will not deliver air to the turbine shrouds. The resulting lack of cooling air can cause significant damage or destruction of the shrouds.

### BRIEF SUMMARY OF THE INVENTION

These and other shortcomings of the prior art are addressed by embodiments of the present invention, which provides a hanger for a turbine shroud which is resistant to being blocked by debris.

According to one embodiment of the invention, a turbine shroud hanger apparatus for a gas turbine engine includes: (a) an arcuate shroud hanger having at least one cooling hole passing therethrough, the cooling hole having an inlet and an outlet; and (b) a filter carried by the shroud hanger positioned upstream of the inlet of the cooling hole, the filter having a plurality of openings formed therethrough which are sized to permit air flow through the cooling hole while preventing the entry of debris particles larger than a preselected size into the cooling hole.

According to another embodiment of the invention, turbine shroud apparatus for a gas turbine engine includes: (a) an arcuate shroud hanger having at least one cooling hole passing therethrough, the cooling hole having an inlet and an outlet; (b) a filter carried by the shroud hanger positioned upstream of the inlet of the cooling hole, the filter having a plurality of openings formed therethrough which are sized to permit air flow through the cooling hole while preventing the entry of debris particles larger than a preselected size into the cooling hole; and (c) an arcuate shroud segment mounted to the shroud hanger, the shroud segment and the shroud hanger collectively defining a shroud plenum which is in fluid communication with the outlet of the at least one cooling hole.

### BRIEF DESCRIPTION OF THE DRAWINGS

Embodiments of the invention may be best understood by reference to the following description taken in conjunction with the accompanying drawing figures in which:

FIG. 1 is a schematic cross-sectional view of a turbine section of a gas turbine engine, incorporating a shroud hanger constructed according to an embodiment of the present invention;

FIG. 2 is a partially sectioned perspective view of a shroud hanger shown in FIG. 1, having a debris filter installed therein;

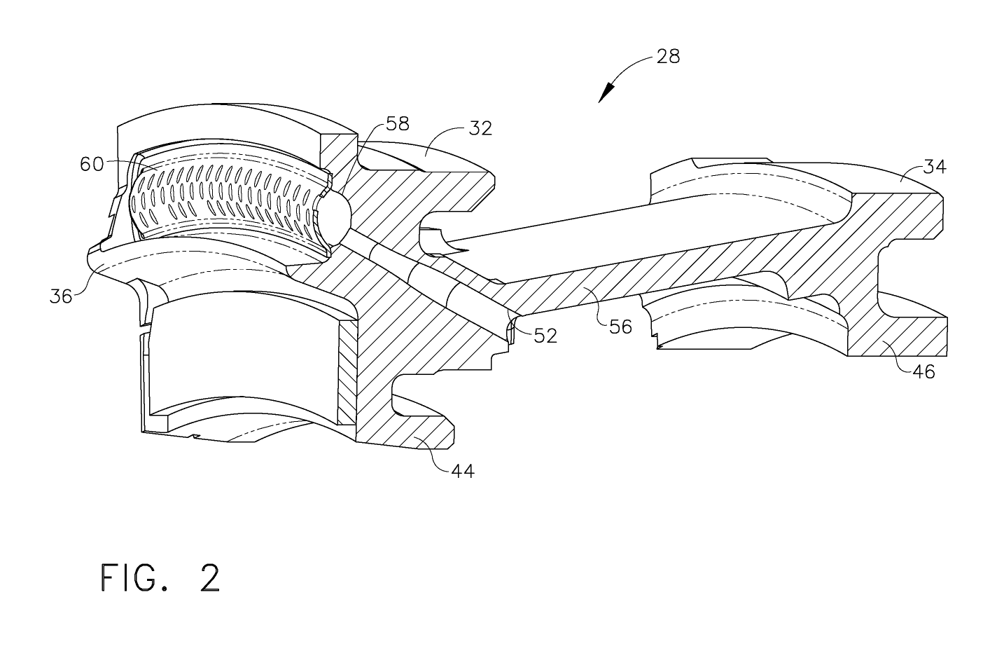

FIG. 3 is a front elevational view of the shroud hanger shown in FIG. 2;

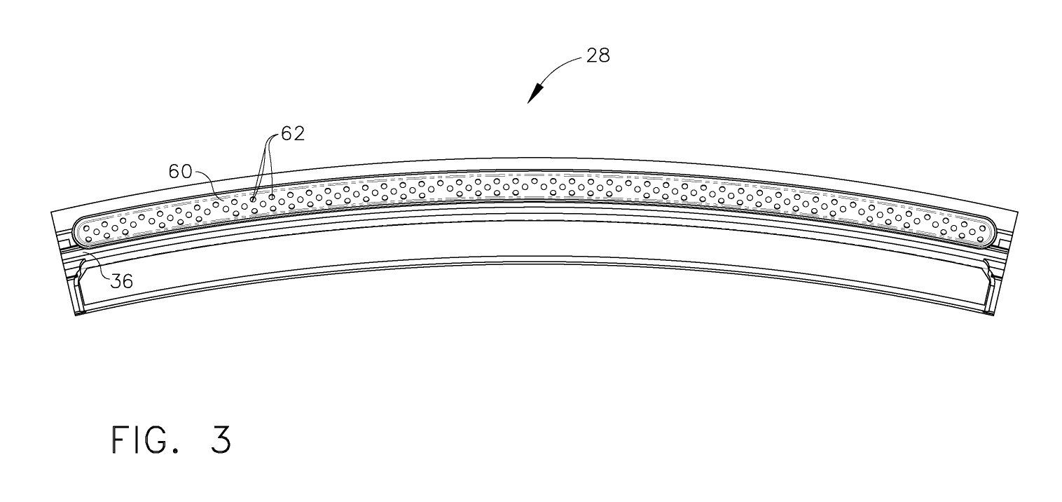

FIG. 4 is a partial perspective view of the shroud hanger shown in FIG. 2, with the filter removed to show the interior of the shroud hanger; and

FIG. 5 is a partial perspective view of the shroud hanger of FIG. 2 with the filter installed.

### DETAILED DESCRIPTION OF EXEMPLARY EMBODIMENTS OF THE INVENTION

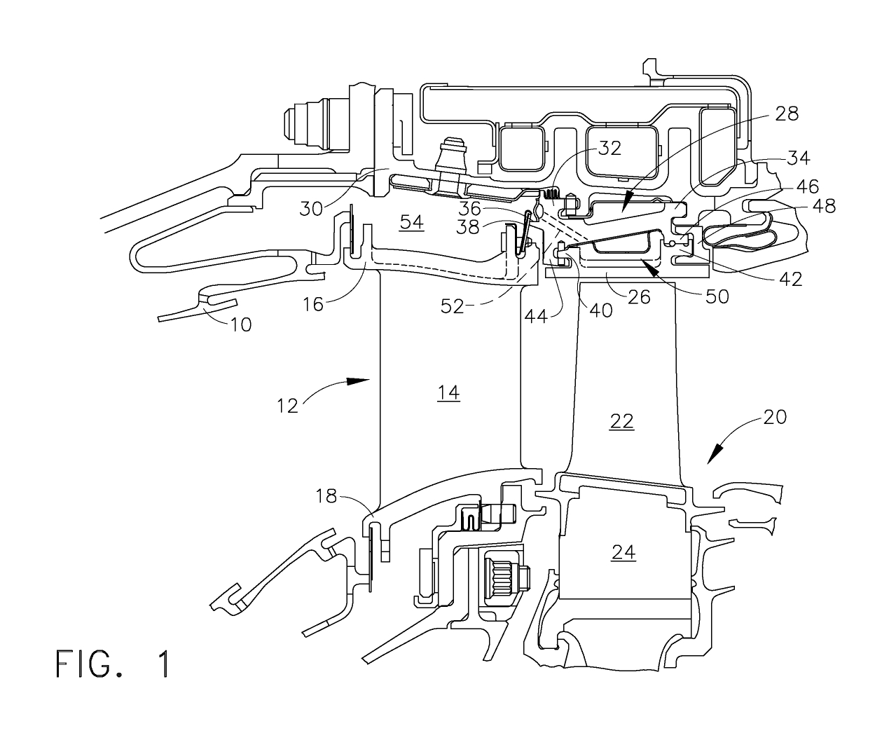

Referring to the drawings wherein identical reference numerals denote the same elements throughout the various views, FIG. 1 depicts a portion of a high pressure turbine, which is part of a gas turbine engine of a known type. The function of the high pressure turbine is to extract energy from high-temperature, pressurized combustion gases from an upstream combustor 10 and to convert the energy to mechanical work, in a known manner. The high pressure turbine drives an upstream compressor (not shown) through a shaft so as to supply pressurized air to the combustor 10.

In the illustrated example, the engine is a turbofan engine and a low-pressure turbine would be located downstream of the high pressure turbine 10 and coupled to a shaft driving a fan and optionally a low-pressure compressor or “booster”. However, the principles described herein are equally applicable to turboprop, turbojet, and turboshaft engines, as well as turbine engines used for other vehicles or in stationary applications.

The high pressure turbine includes a nozzle 12 which comprises an array of circumferentially spaced airfoil-shaped hollow vanes 14 that are supported between an arcuate, segmented outer band 16 and an arcuate, segmented inner band 18. The vanes 14, outer band 16 and inner band 18 are arranged into a plurality of circumferentially adjoining nozzle segments that collectively form a complete 360° assembly. The outer and inner hands 16 and 18 define the outer and inner radial flowpath boundaries, respectively, for the hot gas stream flowing through the nozzle 12. The vanes 14 are configured so as to optimally direct the combustion gases to a rotor 20.

The rotor 20 includes a array of airfoil-shaped turbine blades 22 extending outwardly from a disk 24 that rotates about the centerline axis of the engine. A shroud comprising a plurality of arcuate shroud segments 26 is arranged so as to closely surround the turbine blades 22 and thereby define the outer radial flowpath boundary for the hot gas stream flowing through the rotor 20.

The shroud segments 26 are carried by arcuate shroud hangers 28, which are in turn mounted to an annular casing 30. Each shroud hanger 28 is mounted to the casing 30 by forward and aft flanges 32 and 34 which engage mating mechanical features of the casing 30. Each shroud hanger 28 also includes a seal lip 36 which contacts a leaf seal 38 of a known type carried by the outer band 16 of the upstream turbine nozzle 12.

Each shroud hanger 28 is mourned to the casing 30 by forward and aft flanges 32 and 34 which engage mating mechanical features of the casing 30. Each shroud hanger 28 also includes a seal lip 36 which contacts a leaf seal 38 of a known type carried by the outer band 16 of the upstream turbine nozzle 12.

Each shroud segment 26 includes an arcuate base having radially-outwardly-extending forward and aft rails which carry axially-extending forward and aft mounting flanges 40 and 42, respectively. The forward mounting flanges 40 engage forward hooks 44 of the shroud hangers 28. The aft mounting flanges 42 are clamped against aft hooks 46 of the shroud hangers 28 by a plurality of retaining members 48 commonly referred to as C-clips.

When assembled, the backside of the shroud segments 26 and the shroud hangers 28 cooperate to form a shroud plenum 50. A plurality of cooling holes 52 extend through each shroud hanger 28. The cooling holes 52 are generally axially aligned and serve to pass cooling air from a nozzle plenum 54 (which is itself supplied from a source such as compressor bleed air) through the shroud hanger 28 to the shroud plenum 50, where it is used for convection, impingement, and/or film cooling of the shroud segment 26 as needed, in a conventional manner.

The shroud hangers 28 may be constructed from a material such as a known cobalt, nickel, or steel-based superalloy which has acceptable strength at the elevated temperatures of operation in a gas turbine engine. Various superalloys are commercially available under trade names such as INCONEL, HASTELLOY, and RENE. The shroud hangers 28 may be formed from castings which are then machined to final dimensions.

In contrast to the prior art, the shroud hangers 28 are provided with filters 60 mounted over the grooves 58 to prevent debris from obstructing the cooling holes 52. Each filler 60 takes the form of a wall or a panel with a plurality of openings 62 formed therein. The size and number of the openings 62 is selected to be small enough to exclude debris considered to pose a risk of blocking the cooling holes 52, and large enough to be reasonably producible and pass sufficient airflow without an excessive number of openings. Generally, the openings 62 would smaller than the cooling holes 52 by about 0.1 mm (0.005 in.) to about 0.25 mm (0.010 in.). In the illustrated example, the diameter of the openings 62 may be in the range of about 1.0 mm (0.040 in.) to about 1.3 mm (0.050 in.).

In the illustrated example the filter 60 has a convex outward curved shape. In other words, the center of the filter 60 bulges axially forward relative to its perimeter. This shape has been found to minimize the pressure differential across the cooling holes 52 that would otherwise would tend to hold particles of debris against the filter 60, and to effectively allow high-velocity cooling air flow to clear debris away from the front face of the filter 60, rather than holding debris in place against the filter 60. However, depending upon the specific application, the filter 60 could also be flat.

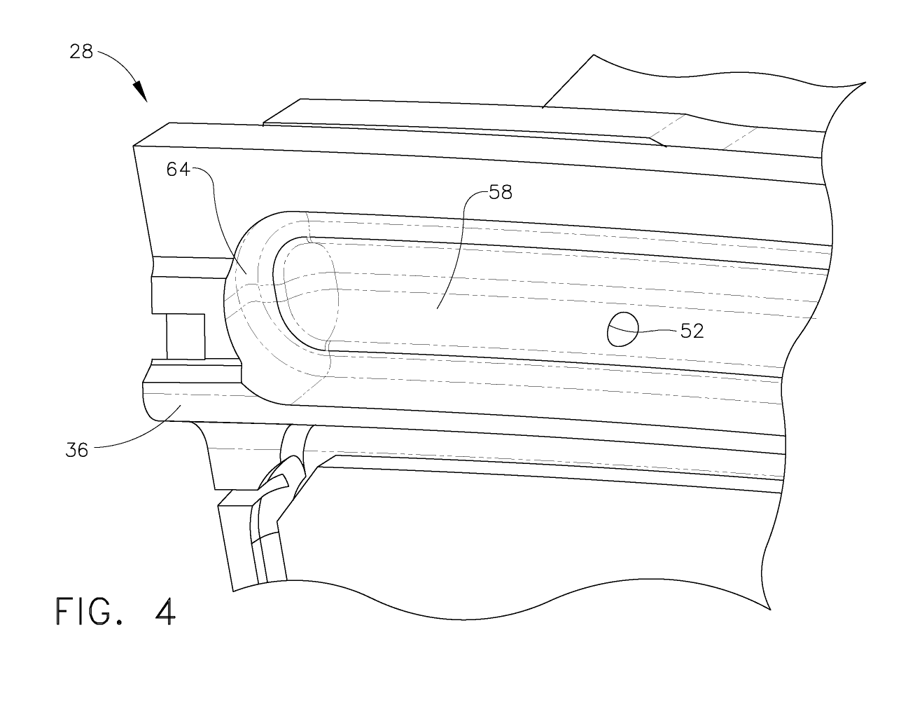

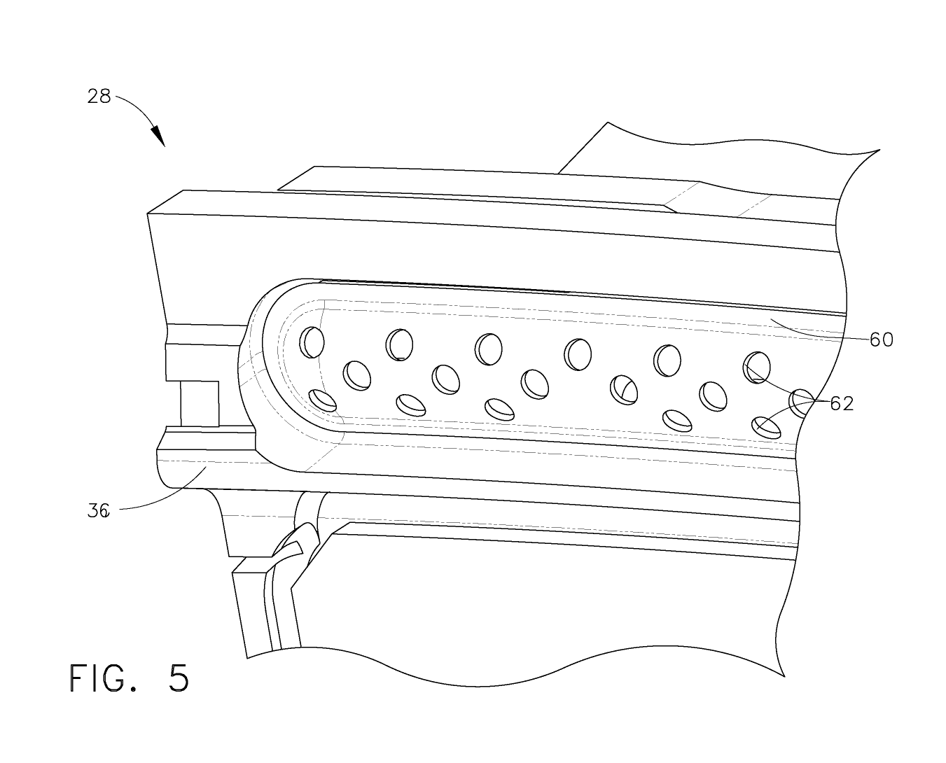

The filter 60 may be mounted in the groove 58 by any method which will keep it secure during engine operation. Examples of known suitable methods include welding the perimeter of the filter 60 to the shroud hanger 28, using either tack welds or a continuous bead, brazing, or combinations thereof. As best seen in FIGS. 4 and 5, a ledge 64 is formed around the perimeter of the groove 58 to receive the filter 60. The ledge 64 serves to positively position the filter 60 and to provide a faying surface for a bonding operation.

In the particular example, the filters 60 are constructed from metal sheet stock approximately 0.25 mm (0.010 in.) thick. A nonlimiting example of a suitable alloy for this purpose is a cobalt-based alloy commercially known as L-605.

In operation, the filter 60 prevents debris from entering the cooling holes 52 and blocking them, thus ensuring a constant flow of cooling air to the shroud segments 26. Debris is cleaned away from the filter front face by high-velocity air that exits the nozzle plenum 54 through flowpaths that do not have critical small-diameter passages. This will protect the shroud segments 26 from damage and shortened operational life.

The foregoing has described a turbine shroud hanger for a gas turbine engine. While specific embodiments of the present invention have been described, it will be apparent to those skilled in the art that various modifications thereto can be made without departing from the spirit and scope of the invention. Accordingly, the foregoing description of an embodiment of the invention and the best mode for practicing the invention are provided for the purpose of illustration only and not for the purpose of limitation.

What is claimed is:

1. A turbine shroud hanger apparatus for a gas turbine engine, comprising:
an arcuate shroud hanger having at least one cooling hole passing therethrough, the cooling hole having an inlet and an outlet; and
a filter carried by the shroud hanger positioned upstream of the inlet of the cooling hole, the filter having a plurality of openings formed therethrough which are sized to permit air flow through the cooling hole while preventing the entry of debris particles larger than a preselected size into the cooling hole.

2. The apparatus of claim 1 wherein the shroud hanger comprises:
an arcuate body;
forward and aft flanges extending from a radially outer surface of the body; and
forward and aft hooks extending from a radially inner surface of the body.

3. The apparatus of claim 1 wherein:
an arcuate groove is formed in a forward face of the shroud hanger, the groove communicating with the cooling hole; and
the filter is received in the groove.

4. The apparatus of claim 3 wherein a ledge is disposed around the perimeter of the groove, and the filter is mounted against the ledge.

5. The apparatus of claim 1 wherein the filter is secured to the shroud hanger by welding, brazing, or a combination thereof.

6. The apparatus of claim 1 wherein the filter has a convex cross-sectional shape.

7. A turbine shroud apparatus for a gas turbine engine, comprising:
an arcuate shroud hanger having at least one cooling hole passing therethrough, the cooling hole having an inlet and an outlet;
a filter carried by the shroud hanger positioned upstream of the inlet of the cooling hole, the filter having a plurality of openings formed therethrough which are sized to permit air flow through the cooling hole while preventing the entry of debris particles larger than a preselected size into the cooling hole; and
an arcuate shroud segment mounted to the shroud hanger, the shroud segment and the shroud hanger collectively defining a shroud plenum which is in fluid communication with the outlet of the at least one cooling hole.

8. The apparatus of claim 7 wherein the shroud hanger comprises:
an arcuate body;
forward and aft flanges extending from a radially outer surface of the body; and
forward and aft hooks extending from a radially inner surface of the body, where the forward and aft hooks are secured to forward and aft mounting flanges, respectively, of the shroud segment.

9. The apparatus of claim 7 wherein:
an arcuate groove is formed in a forward face of the shroud hanger, the groove communicating with the cooling holes; and
the filter is received in the groove.

10. The apparatus of claim 9 wherein a ledge is disposed around the perimeter of the groove, and the filter is mounted against the ledge.

11. The apparatus of claim 7 wherein the filter is secured to the shroud hanger by welding, brazing, or a combination thereof.

12. The apparatus of claim 7 wherein the filter has a convex cross-sectional shape.
